(19) United States
(12) Patent Application Publication
(10) Pub. No.: US 2012/0210134 A1
(43) Pub. Date: Aug. 16, 2012

(54) METHOD OF SECURING COMMUNICATION

(76) Inventor: Navroop Mitter, Boyds, MD (US)

(21) Appl. No.: 13/370,294

(22) Filed: Feb. 9, 2012

Related U.S. Application Data
(60) Provisional application No. 61/440,894, filed on Feb. 9, 2011.

(51) Int. Cl. H04L 9/28

(52) U.S. Cl. 713/171

(57) ABSTRACT

A method for securing data to be transmitted between a plurality of devices which includes exchanging encryption keys between first and second devices of the plurality of devices, selecting digital rights management (DRM) features for the data which is to be transmitted from the first device, encrypting the data to be transmitted and the selected digital rights management features using at least one distinct key, transmitting the encrypted data and the selected DRM features to the second device and a third device, and decrypting the encrypted data on the second device using the exchanged encryption keys and displaying the data according to the selected DRM features.

### CROSS-REFERENCE TO RELATED APPLICATIONS

This application claims the benefit of U.S. Provisional Patent Application No. 61440894, filed on Feb. 9, 2011, the disclosure of which is incorporated herein in its entirety by reference.

### BACKGROUND OF THE INVENTION:

1. Field of the Invention

The present general inventive concept relates to a method of performing secure messaging between users, and more particularly, to a method of performing secure messaging of data between a plurality of mobile devices.

### SUMMARY OF THE INVENTION:

The present general inventive concept provides a method of performing secure messaging which allows a user to control data, such as an image, text, video, etc., or combinations thereof, which has been sent to another user via mobile communication. In particular, an embodiment of the present invention allows a first user to set conditions on the manner in which data which is to be sent to a second user is accessed and/or viewed, even after the data is sent to the second user.

The present general inventive concept provides a method of performing secure messaging which also allows the first user to (i) set an expiration date or time of the data; (ii) set a permission flag to allow or deny the second user from forwarding and/or exporting the data; and (iii) set a specific number of times the data may be accessed by the second user such that the received data would be inaccessible once this limit has been met.

The present general inventive concept provides a method of performing secure messaging which also reduces a risk of personal data, such as images, texts, videos, etc., or combinations thereof, which have been sent or forwarded to intended recipients from being viewed by unintended recipients.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method for securing data to be transmitted between a plurality of devices, such as mobile devices. The method includes exchanging encryption keys between first and second devices of the plurality of devices, selecting digital rights management (DRM) features for the data which is to be transmitted from the first device, encrypting the data to be transmitted and the selected digital rights management features using at least one distinct key, transmitting the encrypted data and the selected DRM features to the second device, and decrypting the encrypted data on the second device using the exchanged encryption keys and displaying the data according to the selected DRM features. The encrypted data may be transmitted to a third device if an audit requirement occurs. An audit requirement may occur when the data transmitted is subject to regulatory compliance, such as financial regulations, FDA regulations, employment regulations, and the like.

The data may include text data, picture data, audio data, video data, SMS data, and MMS data. The DRM features may include data expiration time, limit on number of times data is viewable, limits on data export rights, and limits on data forwarding rights.

The third device may be a non mobile database. The third device may be able to access, decrypt, and display the received encrypted data without the limits set by the selected DRM features. The encrypted data may be stored within an encrypted database on both the first and second device.

The exchanged encryption keys between the first and second devices may be accessed, maintained, and modified through a key server. The key server may revoke the exchanged keys between the first and second device. The key server may verify whether the first and second device are authorized to communicate with each other. The key server may request status updates from the first and second device to verify whether the devices authorized to communicate with each other.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1A is a flow diagram illustrating an exemplary embodiment of the method for securing data to be transmitted between a plurality of devices according to the present general inventive concept;

FIGS. 1B-1C is a flow diagram illustrating an exemplary embodiment of an enterprise version of the method for securing data to be transmitted between a plurality of devices according to the present general inventive concept;

FIGS. 2A-2F is a flow diagram illustrating an exemplary embodiment of initiating the method for securing data to be transmitted between a plurality of devices according to the present general inventive concept;

FIG. 3A is a flow diagram illustrating an exemplary embodiment of initiating for an individual users of the method for securing data to be transmitted between a plurality of devices according to the present general inventive concept;

FIG. 3B is a flow diagram illustrating an exemplary embodiment of initiating for an enterprise user of the method for securing data to be transmitted between a plurality of devices according to the present general inventive concept;

FIG. 4 is a flow diagram illustrating an exemplary embodiment of key maintenance of the method for securing data to be transmitted between a plurality of devices according to the present general inventive concept;

FIG. 4A is a flow diagram illustrating an exemplary embodiment of individual users both having an application according to the method for securing data to be transmitted between a plurality of devices of present general inventive concept installed; and

FIG. 4B is a flow diagram illustrating an exemplary embodiment of individual users wherein only one user has the application according to the method for securing data to be transmitted between a plurality of devices of the present general inventive concept installed.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

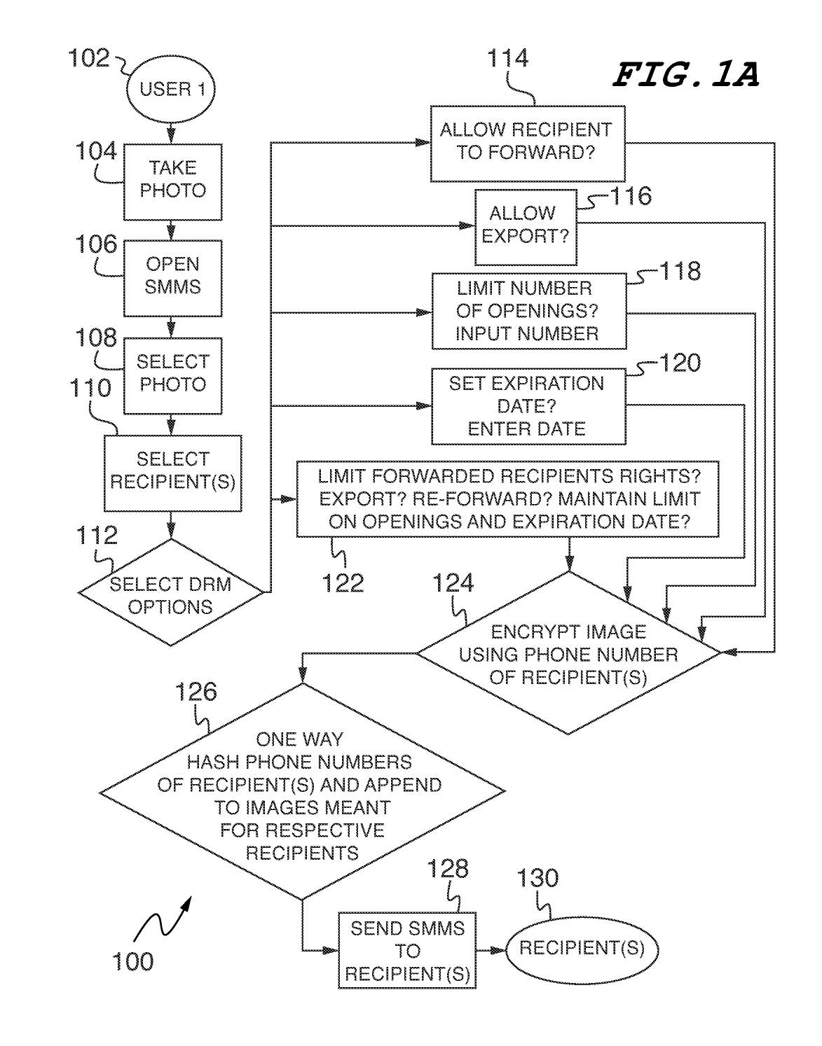

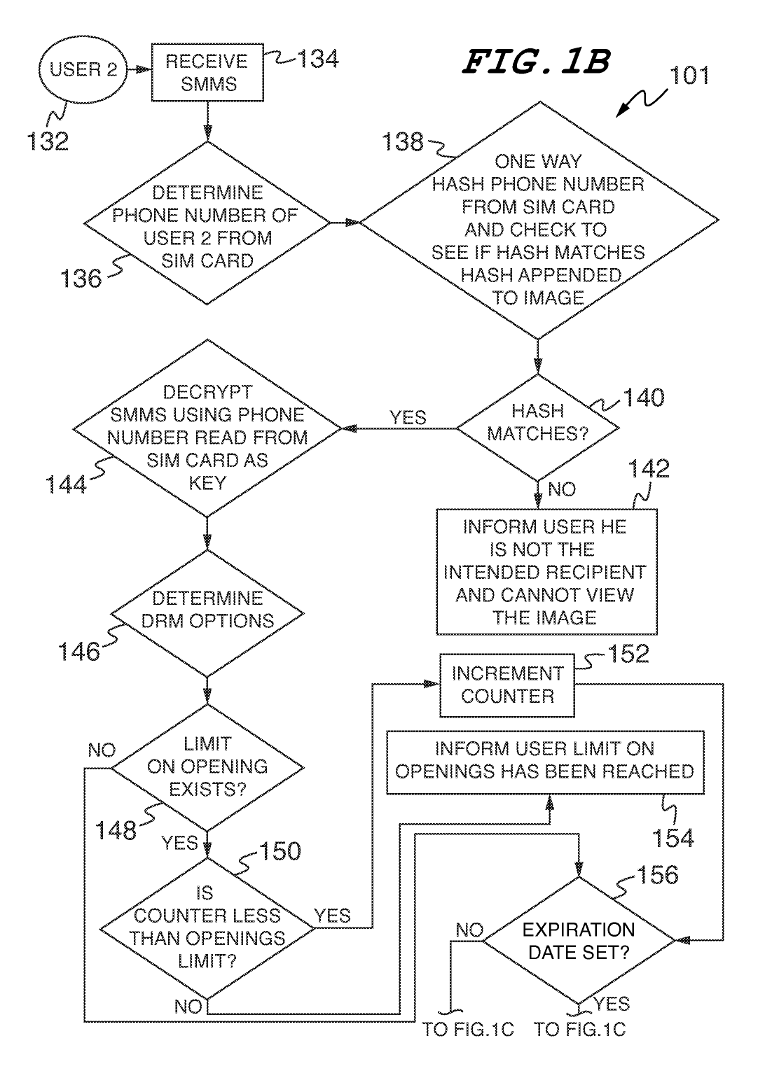

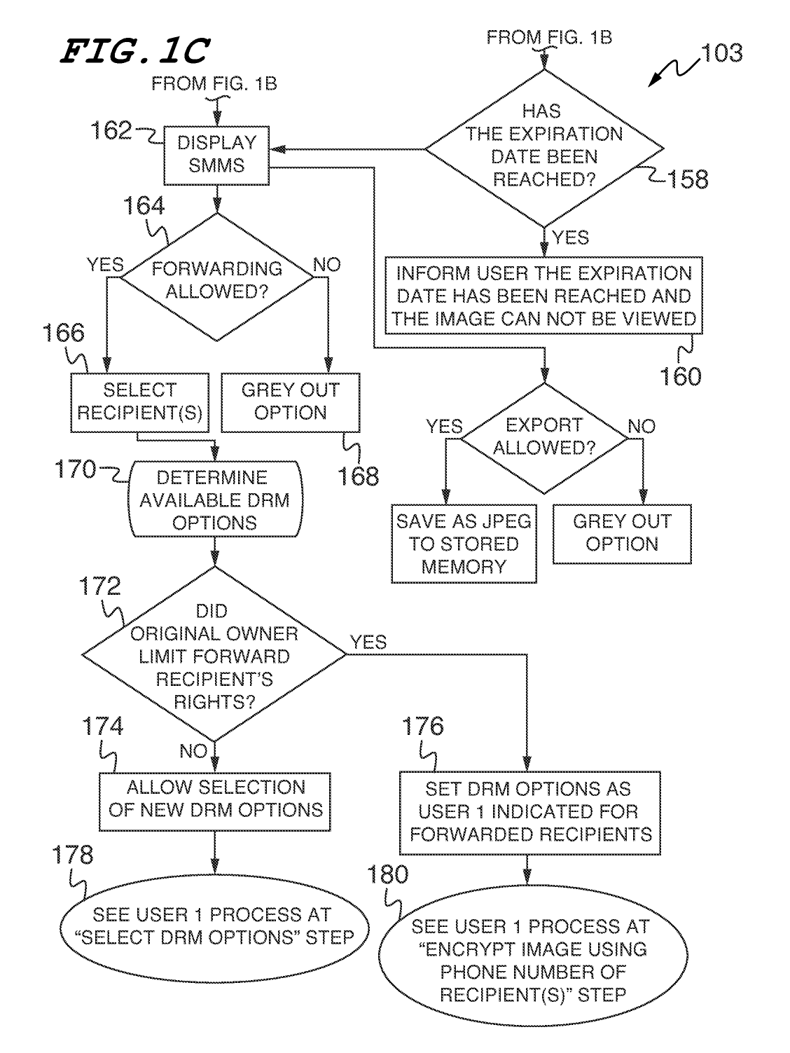

FIG. 1A is a flow diagram illustrating an exemplary embodiment of the method for securing data to be transmitted between a plurality of devices according to the present general inventive concept.

Referring to FIG. 1A, an exemplary embodiment of the method according to the present invention includes a first user 102 taking a photo 104 from a first mobile device. The first user 102 would then open the Secure Messaging Application 106 from a first mobile device, select the photo 108 taken previously 104, select the desired recipients 110, select the desired digital rights management limitations 112 on how and when the photo 104 may be forwarded to other recipients 114 by the current recipients 130, exported 116, the number of times 118 the photo 104 may be viewed by the current recipients 130, and the date and/or time 120 the photo 104 will no longer be available to recipients 130.

The first user 102 would then have the option to select the desired digital rights management limitations 122 on how and when the photo 104 may viewed and handled should the current recipients 130 forward the photo 104 to other recipients. The selected digital rights management limitations 112 and the photo 104 are encrypted using the phone number of each of the recipients 130 respectively and combined as a digital payload 124. A one-way hash of the phone number 126 of each of the recipients 130 is appended to the digital payload 124. The digital payload 124 with the appended one way hash of the phone number 126 corresponding to the recipients 130 is transmitted 128 to the recipients 130 over the carrier's SMS/MMS delivery protocol.

FIGS. 1B-1C is a flow diagram illustrating an exemplary embodiment of the method for processing secured data transmitted between a plurality of devices according to the present general inventive concept. Referring to FIG. 1B-1C, an exemplary embodiment of the method according to the present invention included a second user 132 receiving a secured digital payload 134 on a second mobile device. The phone number 136 of the second user 132 is determined from the SIM card or memory of the second device. The phone number 136 is then one way hashed 138 and compared to the one way hashed phone number received in the secured digital payload 134. If the comparison 140 of the one way hash 138 of the phone number 136 does not match the one way hashed phone number received in the secured digital payload 134, the second user 132 is informed 142 that access to the data in the secured digital payload 134 is not allowed and nothing will be displayed.

If the comparison 140 of the one way hash 138 of the phone number 136 does match the one way hashed phone number received in the secured digital payload 134, the remainder of the secured digital payload 134 is decrypted 144 using the phone number 136. The digital rights limitations 146 are read from the decrypted digital payload 144. If a limit on the number of times 148 the decrypted digital payload 144 can be viewed does not exist, the Secure Messaging Application proceeds to check for an expiration date or time 156 in the digital rights limitations 146. If a limit on the number of times 148 the decrypted digital payload 144 can be viewed does exist, the counter 152 is compared 150 to the limit on the number of times 148 the decrypted digital payload 144 can be viewed. If on comparison 150 the counter 152 is found to be greater than the limit 148, then the second user 132 is informed 154 that user has exceed the views limit 148 and the decrypted digital payload 144 is not displayed. If on comparison 150 the counter 152 is found to be non-existent a counter 152 specific to this decrypted digital payload 144 is created and incremented to one and the Secure Messaging Application proceeds to check for an expiration date or time 156 in the digital rights limitations 146. If on comparison 150 the counter 152 is found to be less than the limit 148, then the Secure Messaging Application proceeds to check for an expiration date or time 156 in the digital rights limitations 146.

If no expiration date or time 156 exists in the digital rights management limitations 146 the decrypted digital payload 144 is displayed 162. If an expiration date or time 156 does exist in the digital rights limitations 146 a comparison 158 is made to the current date and time. If the current date and time exceed the expiration date and time 156 during comparison 158 the second user 132 is informed 160 that access to the data in the secured digital payload 134 is not allowed and nothing will be displayed.

If the current date and time does not exceed the expiration date and time 156 during comparison 158 the decrypted digital payload 144 is displayed 162. If the second user 132 is not allowed to forward 164 the secured digital payload 134 according to the digital rights management limitations 146 the option to forward the secured digital payload 134 is unavailable and the Secure Messaging Application will not allow such action 168. If the second user 132 is allowed to forward 164 the secured digital payload 134 according to the digital rights management limitations 146 the second user 132 proceeds to select recipients 166, the digital rights management limitations 146 are checked for digital rights limitations 170 that apply to recipients of a forwarded copy of the secured digital payload 134 from the second user 132.

If no digital rights limitations 172 exist in the digital rights limitations 170 for recipients of a forwarded copy of the secured digital payload 134 from the second user 132, the second user 132 is allowed to select new digital rights management limitations 174 for forwarded recipients and the process 178 proceeds as indicated in FIG. 1A. If digital rights limitations 172 exist in the digital rights limitations 170 for recipients of a forwarded copy of the secured digital payload 134 from the second user 132, the digital rights management limitations for the forwarded recipients are set 176 to the values in the digital rights limitations 170 for recipients of a forwarded copy of the secured digital payload 134 from the second user 132 and the process 180 proceeds as indicated in FIG. 1A.

If the second user 132 is not allowed to export 190 the decrypted digital payload 144 according to the digital rights management limitations 146 the option to export the decrypted digital payload 144 is unavailable and the Secure Messaging Application will not allow such action 192. If the second user 132 is allowed to export 190 the decrypted digital payload 144 according to the digital rights management limitations 146 the option to export the decrypted digital payload 144 is available and the Secure Messaging Application proceeds 191 to save the decrypted digital payload 144 in the appropriate format to the storage memory on the second mobile device.

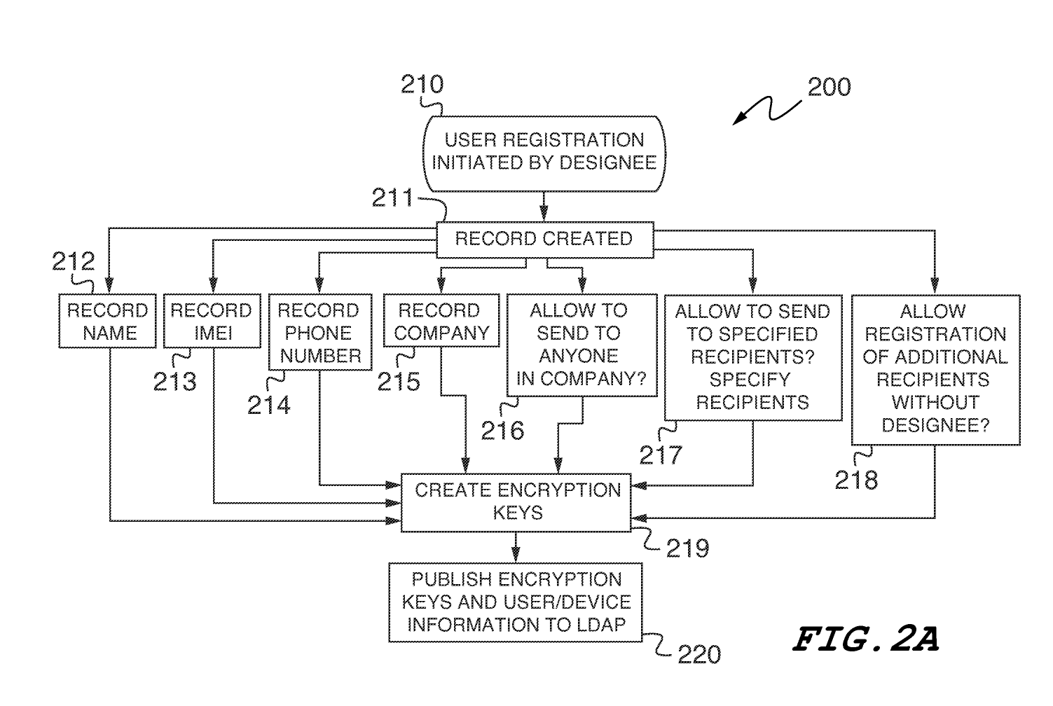

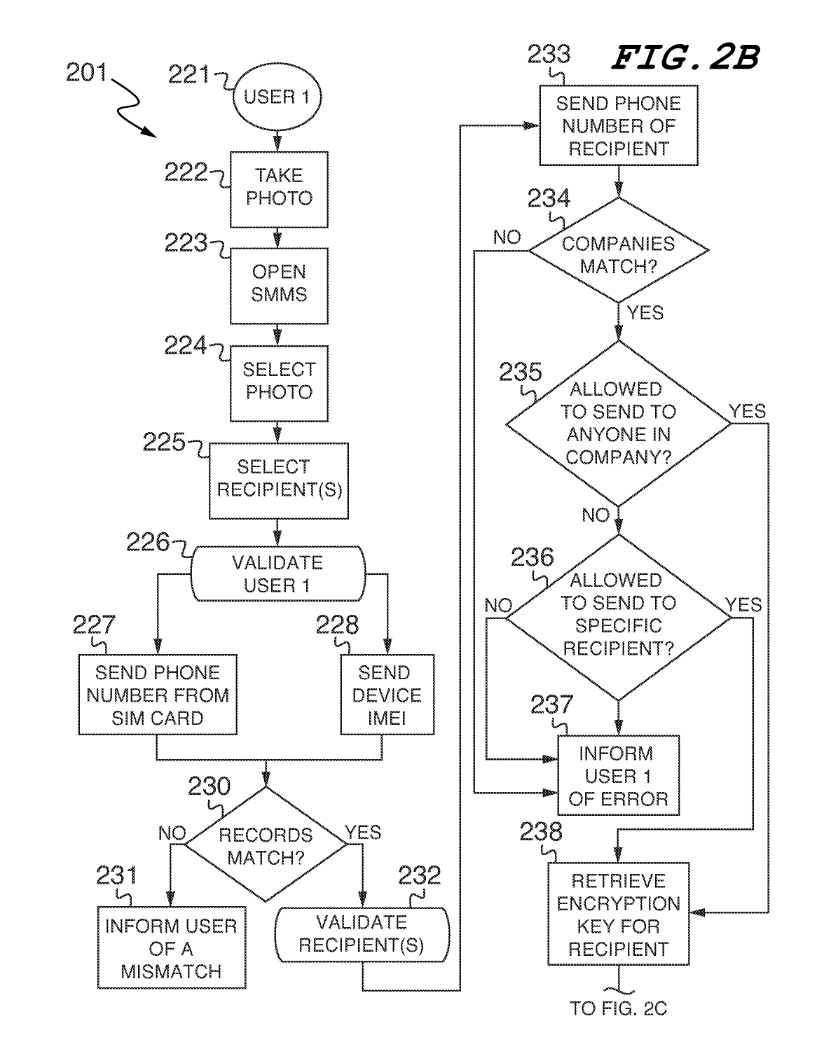

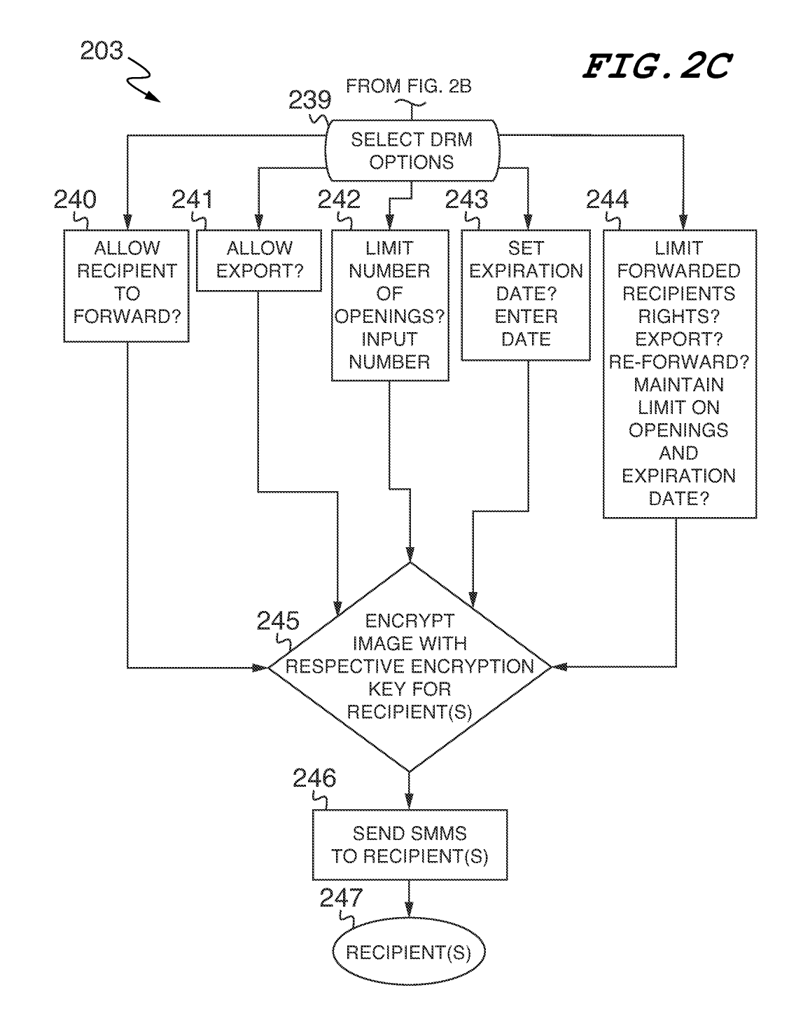

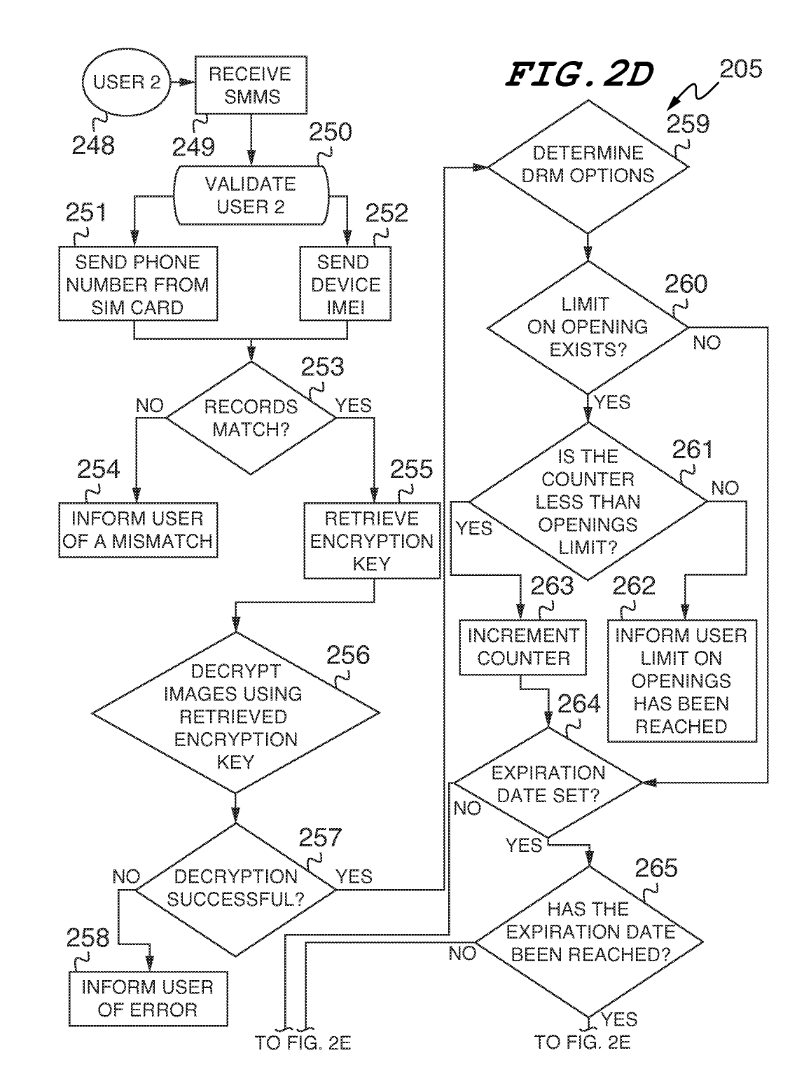

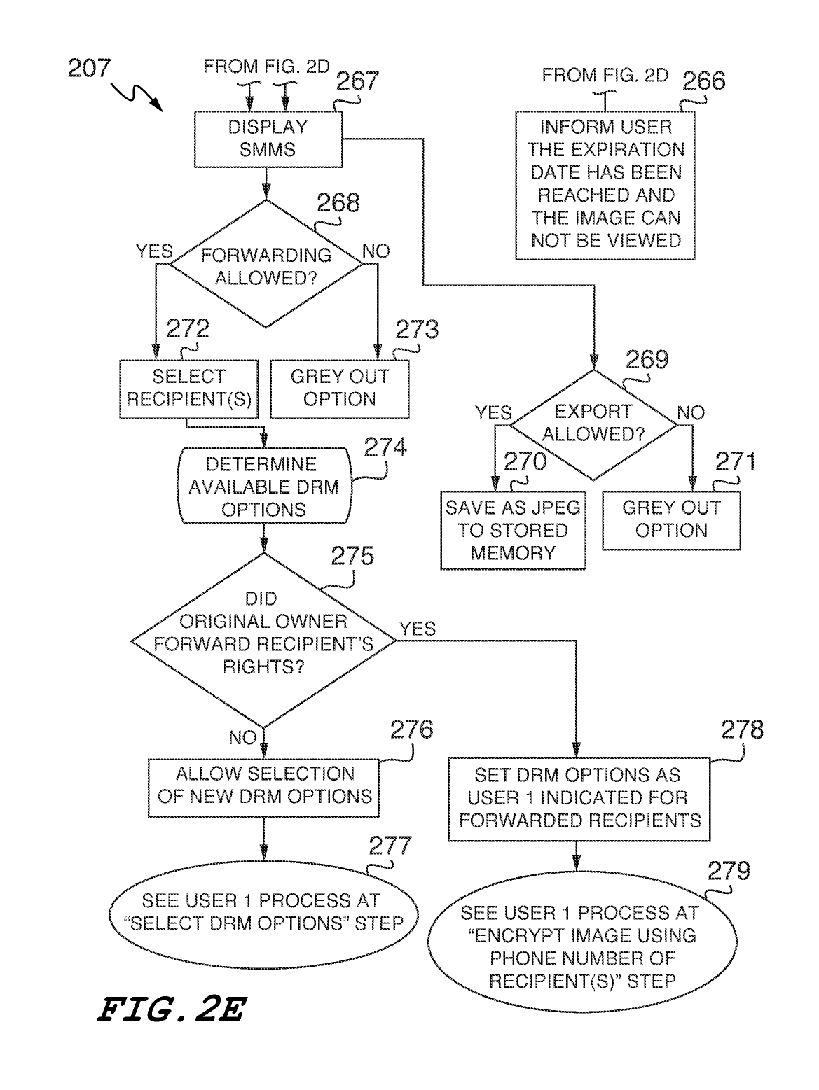

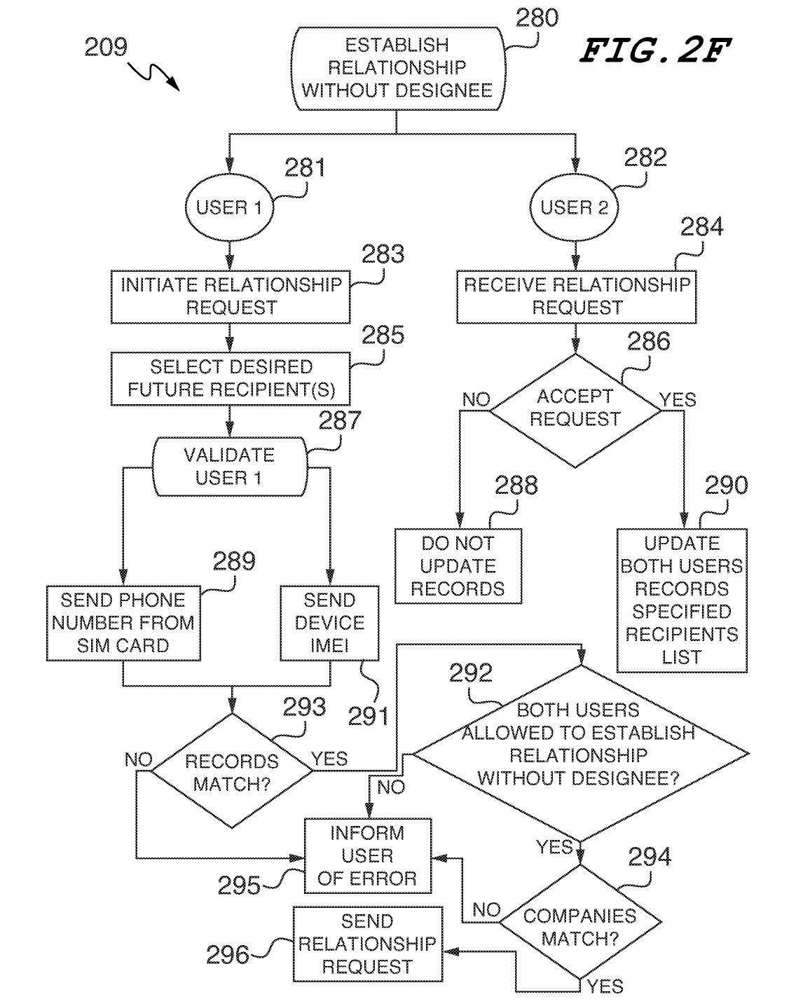

FIGS. 2A-2F is a flow diagram illustrating an exemplary embodiment of initiating the method for securing data to be transmitted between a plurality of devices according to the present general inventive concept. Referring to FIG. 2A, users belonging to a set of users that are managed collectively are registered 200 as users of the method of the present inventive concept that can communicate, subject to limitations, which may be declared, with other users of the set.

A designee 210 initiates the registration process and creates a record 211 that contains the Name of the user to be registered 212, the IMEI or other device identifier 213 possessed by the user to be registered, the phone number 214 of the device possessed by the user to be registered, the name or other identifier 215 of the organization or set to which the user to be registered belongs, whether or not the user to be registered may send secured data to anyone 216 in the organization or set to which the user to be registered belongs, whether the user is limited to only send secured data to a defined list of recipients 217, and whether the user to be registered may initiate the inclusion of others on the list of allowed recipients 218 without the designee 210. Encryption keys 219 specific to the user to be registered are created and published to a directory service, listing or other repository 220.

Referring to FIG. 2B-2C, an exemplary embodiment of the method according to the present invention includes a first user 221 taking a photo 222 from a first mobile device. The first user 221 would then open the Secure Messaging Application 223 from a first mobile device, select the photo 224 taken previously 222 and select the desired recipients 225. The first user 221 would then be validated 226 by sending the phone number 227 of the first mobile device as obtained from the SIM card or memory of the first mobile device and the IMEI or device identifier 228 of the first mobile device and to a designated directory service, listing or other repository as designated in FIG. 2A 220 and comparing this to the record 230 for the first user 221 contained there.

If the values 227 and 228 sent to the designated directory service, listing or other repository as designated in FIG. 2A 220 do not match, the first user 221 is informed and the Secure Messaging Application 223 does not proceed. If the values 227 and 228 sent to the designated directory service, listing or other repository as designated in FIG. 2A 220 do match, the list of desired recipients 225 are validated by sending the phone number of each recipient 233 to the designated directory service, listing or other repository as designated in FIG. 2A 220 and compared to the record for each recipient 233 contained there.

If the recipient 233 is not found in the designated directory service, listing or other repository as designated in FIG. 2A 220 the first user 221 is informed of the error 237. If the company 234 associated with the recipient 233 and the first user 221 are not a match, the first user 221 is informed of the error 237. If the company 234 associated with the recipient 233 and the first user 221 are a match, the flag 235 indicating whether the first user 221 is allowed to send a message to anyone is checked. If the flag 235 is set to yes, then Secure Messaging Application 223 proceeds to obtain the encryption key 238 for the recipient 233.

If the flag 235 is set to no, then the list of allowed recipients 236 for messages from the first user 221 is checked for the presence of the recipient 233. If the recipient 233 is not in the list of allowed recipients 236 for the first user 221, the first user 221 is informed of the error 237. If the recipient 233 is in the list of allowed recipients 236 for the first user 221, the Secure Messaging Application 223 proceeds to obtain the encryption key 238 for the recipient 233. Once all encryption keys 238 are obtained for all recipients 233, the first user 221 proceeds to select the desired digital rights management limitations 239 on how and when the photo 222 may be forwarded to other recipients 240 by the current recipients 247, exported 241, the number of times 242 the photo 222 may be viewed by the current recipients 247, and the date and/or time 243 the photo 222 will no longer be available to recipients 247.

The first user 221 would then have the option to select the desired digital rights management limitations 244 on how and when the photo 222 may viewed and handled should the current recipients 247 forward the photo 222 to other recipients. The selected digital rights management limitations 239 and the photo 222 are encrypted using the encryption keys 238 of each of the recipients 233 respectively and combined as a digital payload 245. The digital payload 245 encrypted with the respective encryption key 238 for a recipient 233 is transmitted 246 to the recipients 233 over the carrier's SMS/MMS delivery protocol.

Referring to FIG. 2D-2E, an exemplary embodiment of the method according to the present invention includes a second user 248 receiving a secured digital payload 249 on a second mobile device. The second user 248 would then be validated 250 by sending the phone number 251 of the second mobile device as obtained from the SIM card or memory of the second mobile device and the IMEI or device identifier 252 of the second mobile device and to a designated directory service, listing or other repository as designated in FIG. 2A 220 and comparing this to the record 253 for the second user 248 contained there. If the values 251 and 252 sent to the designated directory service, listing or other repository as designated in FIG. 2A 220 do not match, the second user 248 is informed and the Secure Messaging Application does not proceed.

If the values 251 and 252 sent to the designated directory service, listing or other repository as designated in FIG. 2A 220 do match the record 253 for the second user 248 contained there, the encryption key 255 required for decryption of secured digital payloads intended for the second user 248 is obtained from the designated directory service, listing or other repository as designated in FIG. 2A 220. An attempt to decrypt 256 the secured digital payload 249 using the encryption key 255 is made. If the decryption 257 is not successful the second user 248 is informed of the error 258. If the decryption 257 is successful, the digital rights limitations 259 are read from the decrypted digital payload 256.

If a limit on the number of times 260 the decrypted digital payload 256 can be viewed does not exist, the Secure Messaging Application proceeds to check for an expiration date or time 264 in the digital rights limitations 259. If a limit on the number of times 260 the decrypted digital payload 256 can be viewed does exist, the counter 263 is compared 261 to the limit on the number of times 260 the decrypted digital payload 256 can be viewed. If on comparison 261 the counter 263 is found to be greater than the limit 260, then the second user 248 is informed 262 that user has exceed the views limit 260 and the decrypted digital payload 256 is not displayed.

If on comparison 261 the counter 263 is found to be non-existent a counter 263 specific to this decrypted digital payload 256 is created and incremented to one and the Secure Messaging Application proceeds to check for an expiration date or time 264 in the digital rights limitations 259. If on comparison 261 the counter 263 is found to be less than the limit 260, then the Secure Messaging Application proceeds to check for an expiration date or time 264 in the digital rights limitations 259. If no expiration date or time 264 exists in the digital rights management limitations 259 the decrypted digital payload 256 is displayed 267.

If an expiration date or time 264 does exist in the digital rights limitations 259 a comparison 265 is made to the current date and time. If the current date and time exceed the expiration date and time 264 during comparison 265 the second user 248 is informed 266 that access to the data in the secured digital payload 256 is not allowed and nothing will be displayed. If the current date and time does not exceed the expiration date and time 264 during comparison 265 the decrypted digital payload 256 is displayed 267. If the second user 248 is not allowed to forward 268 the secured digital payload 249 according to the digital rights management limitations 259 the option to forward the secured digital payload 249 is unavailable and the Secure Messaging Application will not allow such action 273.

If the second user for recipients of a forwarded copy of the secured digital payload 249 from the second user 248 and the process 279 proceeds as indicated in FIG. 2B-2C. If the second user 248 is not allowed to export 269 the decrypted digital payload 256 according to the digital rights management limitations 259 the option to export the decrypted digital payload 256 is unavailable and the Secure Messaging Application will not allow such action 271. If the second user 248 is allowed to export 269 the decrypted digital payload 256 according to the digital rights management limitations 259 the option to export the decrypted digital payload 256 is available and the Secure Messaging Application proceeds 270 to save the decrypted digital payload 256 in the appropriate format to the storage memory on the second mobile device.

Referring to FIG. 2F, users belonging to a set of users that are managed collectively that are allowed to establish a relationship to communicate securely without a designee are provided a process 280 to establish a relationship without a designee. A first user 281 initiates a relationship request 283 and selects recipients 285 to communicate with securely in the future. The first user 281 would then be validated 287 by sending the phone number 289 of the first mobile device as obtained from 248 is allowed to forward 268 the secured digital payload 249 according to the digital rights management limitations 259 the second user 248 proceeds to select recipients 272, the digital rights management limitations 259 are checked for digital rights limitations 274 that apply to recipients of a forwarded copy of the secured digital payload 249 from the second user 248.

If no digital rights limitations 275 exist in the digital rights limitations 274 for recipients of a forwarded copy of the secured digital payload 249 from the second user 248, the second user 248 is allowed to select new digital rights management limitations 276 for forwarded recipients and the process 277 proceeds as indicated in FIG. 2B-2C. If digital rights limitations 275 exist in the digital rights limitations 274 for recipients of a forwarded copy of the secured digital payload 249 from the second user 248, the digital rights management limitations for the forwarded recipients are set 278 to the values in the digital rights limitations 274 the SIM card or memory of the first mobile device and the IMEI or device identifier 291 of the first mobile device to a designated directory service, listing or other repository as designated in FIG. 2A 220 and comparing this to the record 293 for the first user 281 contained there.

If the values 289 and 291 sent to the designated directory service, listing or other repository as designated in FIG. 2A 220 do not match, the first user 281 is informed and the Secure Messaging Application does not proceed. If the values 289 and 291 sent to the designated directory service, listing or other repository as designated in FIG. 2A 220 do match, checks to determine if both the first user 281 and the second user 282 are allowed to establish a relationship without a designee 292 and if the name or other identifier of the organizations or sets to which both the first user 281 and the second user 282 match 294. If either check 292 or 294 is false, the first user 281 is informed and the Secure Messaging Application does not proceed. If both check 292 and 294 are true, a relationship request 296 is sent to the second user 282. A second user 282 receives a relationship request 284.

If the second user 282 does not accept the request 286 then the neither record is updated 288. If the second user 282 does accept the request 286, then both the record of the first user 281 and the record of the second user 282 are updated 290 to include a reference to the other on their respective defined lists of recipients with whom they may communicate securely.

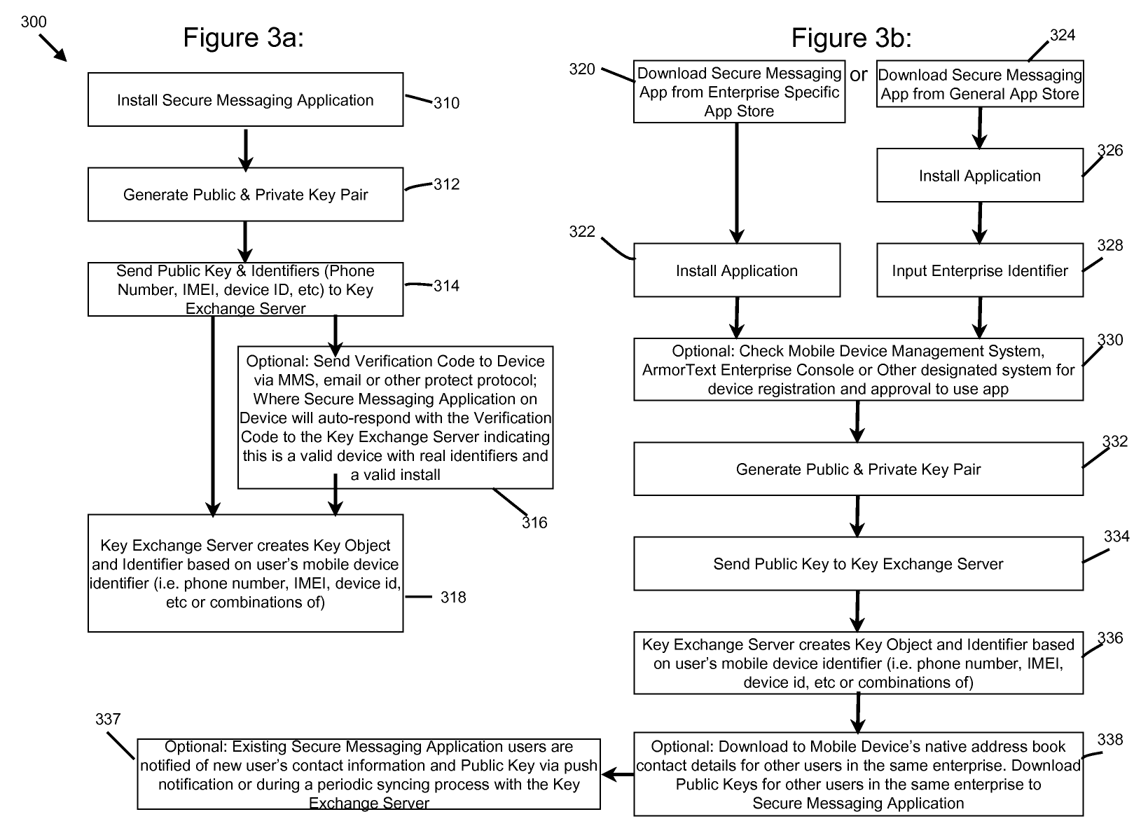

FIG. 3A is a flow diagram illustrating an exemplary embodiment of initiating for individual users of the method for securing data to be transmitted between a plurality of devices 300 according to the present general inventive concept. Referring to FIG. 3A, individual users of the method of the present inventive concept would install an application which incorporates the method for securing data to be transmitted between a plurality of devices 300 (hereinafter, “application”) onto a device, such as a mobile device. However the present general inventive concept is not limited thereto. Once the individual user has installed the Secure Messaging Application 310 onto the device, the application would generate a Public and Private key pair 312. The Application would then send the Public Key along with identification information of the device to a Key Exchange server 314. The identification information may include a phone number, IMEI, or other device ID of the device. In an exemplary embodiment, a verification code may be sent by the Key Exchange server to the device through MMS, email, or other protect protocols, wherein the application would auto-respond by sending the received verification code to the Key Exchange server 316.

The Key exchange server creates Key Object and identifier based on the individual user's mobile device 318. For instance, the key exchange server would create a key object and identifier according to the phone number, IMEI, or other device ID of the user's device.

FIG. 3B is a flow diagram illustrating an exemplary embodiment of initiating for an enterprise user of the method for securing data to be transmitted between a plurality of devices according to the present general inventive concept. Referring to FIG. 3B, an enterprise user would download and install an enterprise version of the application onto a device, such as a mobile phone. 320,322. In an exemplary embodiment, the enterprise user would be required to enter a unique Enterprise identifier corresponding to the user's company 328. In an exemplary embodiment, a Mobile Device management system may also be used to for device registration and to authorize use of particular applications, including the application according to the present general inventive concept 330.

The enterprise version of the application would then generate a Public and Private key pair 332. The application would then send the public key to a Key Exchange server 334. The Key exchange server may then create a key object and identifier based on the enterprise user's mobile device. In exemplary embodiments, the Key exchange server may utilize device information such as phone number, IMEI, other device ID of the device, or combinations thereof to create the Key Object and/or the Identifier 336.

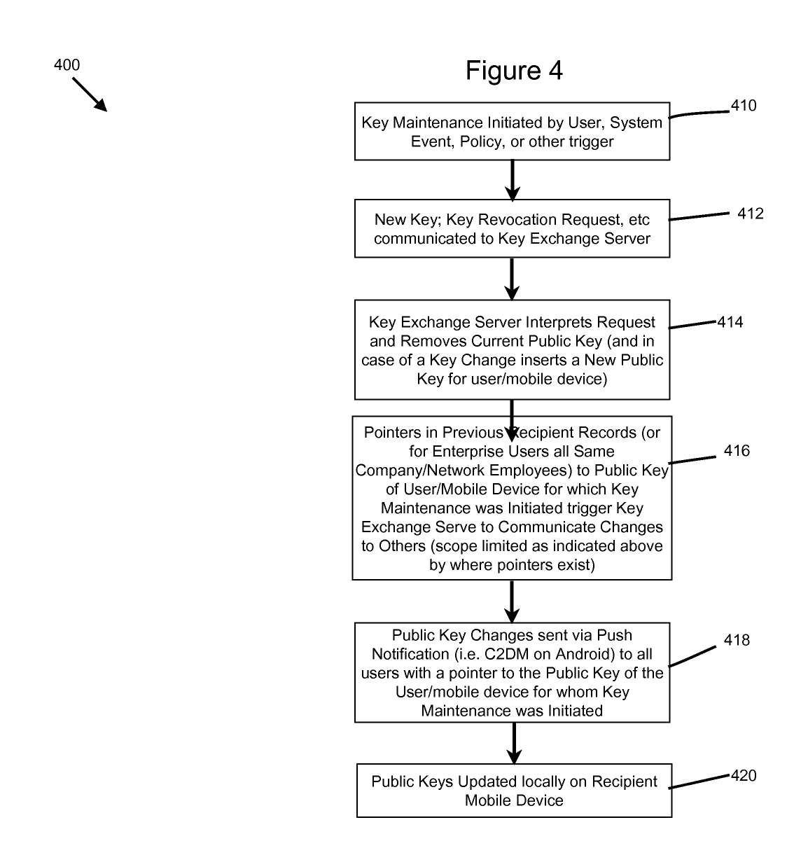

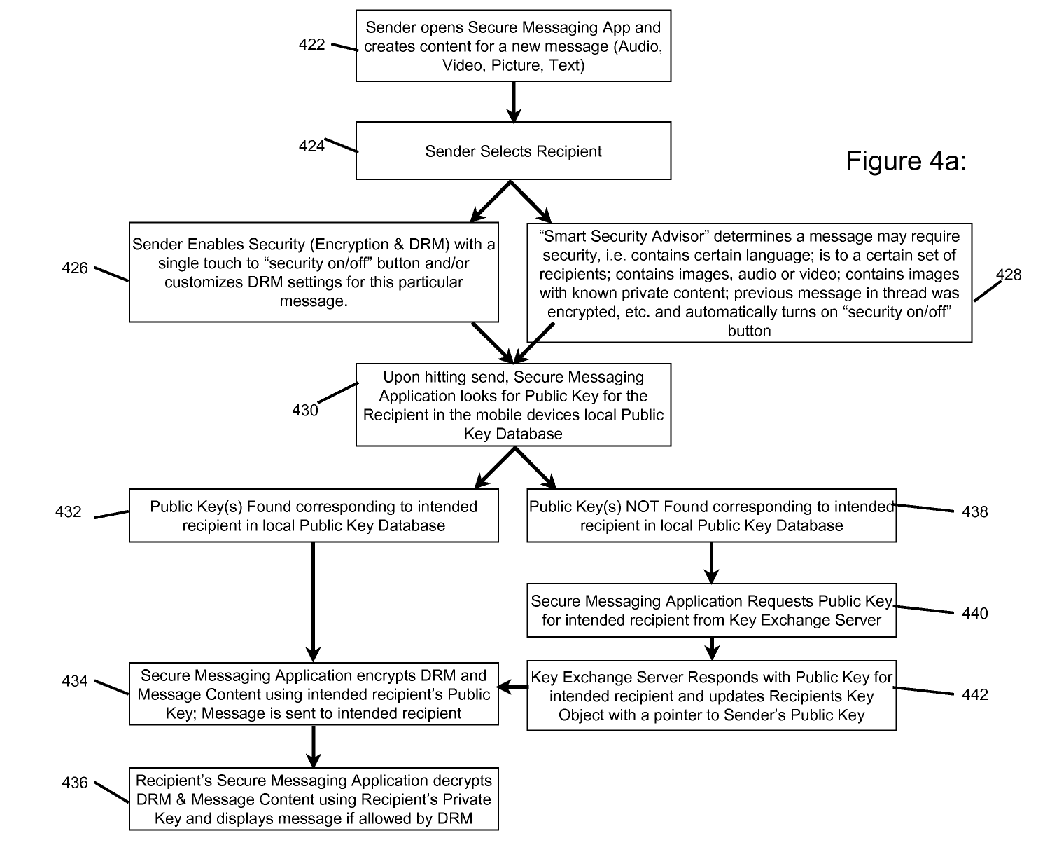

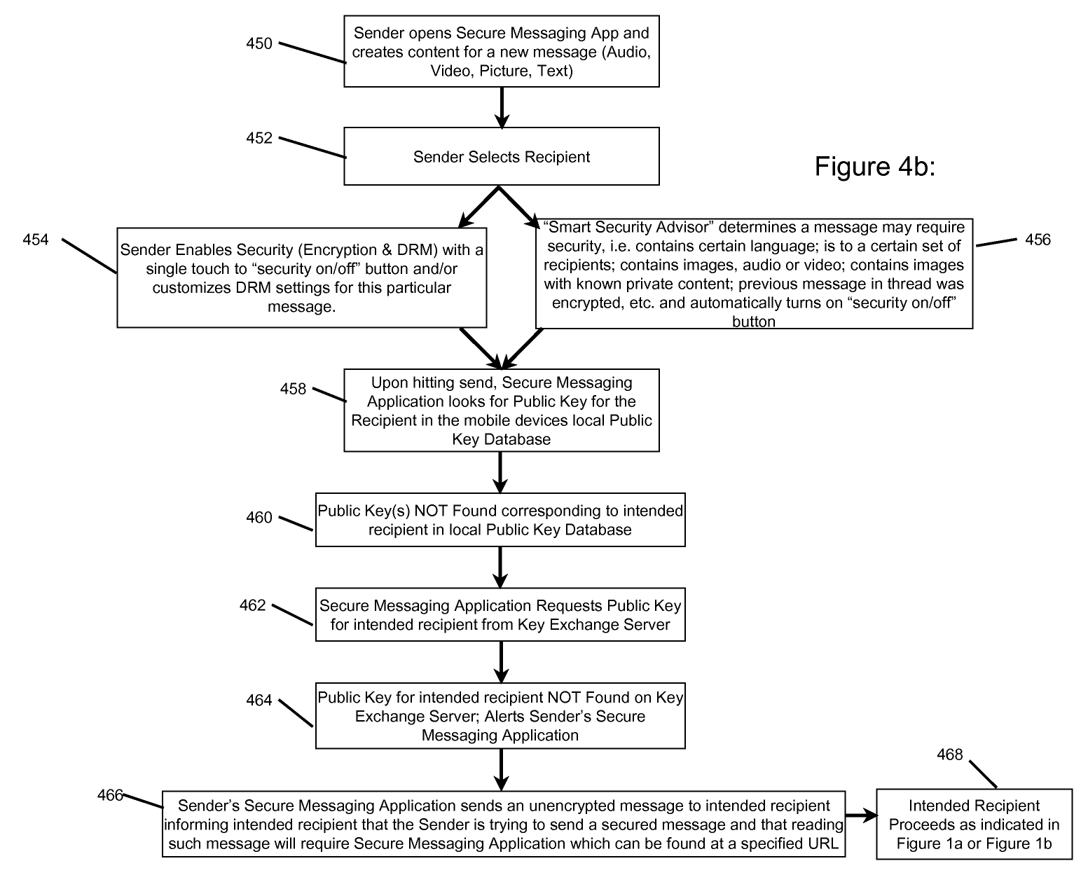

FIG. 4 is a flow diagram illustrating an exemplary embodiment of key maintenance of the method for securing data to be transmitted between a plurality of devices according to the present general inventive concept. Referring to FIG. 4, the Key maintenance 400 may be initiated by the User, the enterprise user, the Key Exchange server, or a predefined policy or trigger 410. In exemplary embodiments, the Key Exchange Server may issue new keys or revocate existing keys according to requests made by the enterprise user 412. The Key exchange server interprets the requests made by the enterprise user 412 and may remove the public keys associated with the enterprise user 414. In exemplary embodiments, the Key exchange server may replace an existing public key with a new public key 414.

FIG. 4A is a flow diagram illustrating an exemplary embodiment of two individual users both having an application according to the method for securing data to be transmitted between a plurality of devices of present general inventive concept installed. Referring to FIG. 4A, a first user (i.e., a sender) opens the Secure Messaging Application and creates content data for a new message which is to be sent to a second user (i.e., a receiver) 422. The sender selects a receiver or recipient 424 from within the device, such as a mobile device. In an exemplary embodiment, the sender enables Security with the selection of a “security on/off” button and user customizable DRM settings. In an exemplary embodiment, the sender may enable the Security feature with the use of a single button.

In an alternative exemplary embodiment, the present general inventive concept includes a “smart security advisor” which determines whether the data the sender selects to send to the recipient requires the security feature 428. In particular, the “smart security advisor” may determine based on the type of data, the content within the data, or the selected recipients by the sender whether to automatically activate the security feature, so that the sent data would be encrypted and include defined DRM features 428. In an exemplary embodiment, the “smart security advisor” may automatically activate the security feature for data which is to be sent to the recipient when the data includes certain language, is sent to particular recipients, contains images, audio, and/or video, contains images with known private content, or was in response to a previous thread which was protected by the security feature 428.

In the present exemplary embodiment, upon hitting the send button, the Secure Messaging Application searches for Public Key for the recipient within a local public key database within the mobile device 430.

When the Secure Messaging Application finds a public key corresponding to the selected recipient(s) 432, the Secure Messaging Application encrypts the data and DRM features using the selected recipient(s) public key and then sends the encrypted data and the DRM features to the selected recipients 434. Upon receipt, the Secure Messaging Application installed on the mobile device of the selected recipient decrypts the received data and DRM features using the recipient's private key, and then displays the data according to the parameters defined by the selected DRM features 436.

When the Secure Messaging Application does not find a public key corresponding to the selected recipient(s) 438, the Secure Messaging Application requests a public key for the selected recipient from the Key exchange server 440. The Key exchange server may respond with a public key for the intended recipient and then may update the recipient's key object with a pointer to the sender's public key 442. The Secure Messaging Application then encrypts the data and DRM features using the selected recipient(s) public key and then sends the encrypted data and the DRM features to the selected recipients 434.

FIG. 4B is a flow diagram illustrating an exemplary embodiment of individual users wherein only one user has the application according to the method for securing data to be transmitted between a plurality of devices of the present general inventive concept installed. Referring to FIG. 4B, in an exemplary embodiment, the sender opens the Secure Messaging Application and creates content which is to be sent to a recipient 450. The sender selects a desired recipient 452 and may then manually enable the Security feature by selecting a single “security on/off” button 454. However, the present general inventive concept is not limited thereto.

In exemplary embodiments, the Secure Messaging Application may include a “smart security advisor” which automatically determines whether the content created by the user should be protected by the security feature 456. In particular, the “smart security advisor” determines whether the data the sender selects to send to the recipient requires the security feature enabled. That is, the “smart security advisor” may determine based on the type of data, the content within the data, or the selected recipients by the sender whether or not to automatically activate the security feature, so that the sent data would be encrypted and include defined DRM features. In an exemplary embodiment, the “smart security advisor” may automatically activate the security feature for data which is to be sent to the recipient when the data includes certain language, is sent to particular recipients, contains images, audio, and/or video, contains images with known private content, or was in response to a previous thread which was protected by the security feature 456. The security messaging application also includes encrypting those messages which meet audit requirements using a distinct key/keys for audit purposes, transmitting the encrypted messages which meet audit requirements to a distinct, non-mobile, repository for viewing by auditors without the limits imposed by the Digital Rights Management Features selected by the sender, and decrypting messages which met audit requirements and were placed in an external repository as needed when such action is initiated by an auditor, administrator or other responsible party.

Upon pressing the button to send the data to the selected recipient, the Secure Messaging Application searches for a public key corresponding to the selected recipient within a local public key database within the mobile device of the sender 458.

When the Secure Messaging Application does not find a public key corresponding to the selected recipient(s) 460, the Secure Messaging Application requests a public key for the selected recipient from the Key exchange server 462. However, if the public key corresponding to the selected recipient is not found on the key exchange server, the secure messaging application on the sender's mobile device will display an alert 464.

The secure messaging application on the sender's mobile device may then send an unencrypted message to the selected recipient to inform the recipient that the sender wants to send a secured message to him/her and that accessing such secured message requires a Secure Messaging Application to be installed 466. If the selected recipient downloads and installs the Secure Messaging Application, the sender may then successfully send the data to the selected recipient and the recipient may then access and view the data according to the DRM features selected by the sender 468.

In alternative exemplary embodiments, initially, a first user of a first mobile device may execute an application, which incorporates the method of performing secure messaging according to the present invention in order to begin the secure messaging solution process. The present invention may use conventional SMS and MMS communication protocols, however, the present invention is not limited thereto. That is, in alternative exemplary embodiments, the application may be stored on the first mobile device, such as a computer, mobile telephone, a PDA, a tablet, an IPAD™, or the like, each of which would have a unique identification information, such as a telephone number, IMEI, MAC address, IP address (IPv4 & IPv6) or the like in order to be usable with conventional SMS, MMS or the like communication protocols as well as the application of the present invention.

The first user of the first mobile device (i.e., a first sender) may select data such as images, texts, videos, etc., or combinations thereof, which may either be stored within a memory of the first mobile device or which may be captured by the first mobile device. Next, once the first user selects a desired data that is to be sent to a second user (i.e., a first receiver), the first user may then select a desired first receiver from the first mobile device's address book. The first user may also select between a plurality of options which define the manner in which the selected data may be viewed, stored, exported, and/or shared by the second user to other recipients.

In particular, the first user may select an option which limits access to the selected data that is sent to the second user. For example, the first user may define a specific number of times the selected data may be viewed or accessed by the second user by inputting a desired number, prior to sending the selected data, such that once the second user views the data the specified number of times, the second user would then be prevented from further accessing or viewing the received data.

In addition, in exemplary embodiments, the first user may define an expiration time period or date for which the second user is allowed to view and/or access the received data. That is, the first user may determine whether the second user would be denied access to a received data upon reaching a specified expiration date. Thus, if the second user is to have limited access to the selected data based on a particular time or date, the first user would specify a desired date or time limit before the selected data is sent to the second user and which the second user would have access to the selected data according to the specified date or defined time limit.

For example, the first user may specify that the selected and the sent data may be limited to be viewed by the second user for only five (5) times and/or for only a period of five (5) days. Therefore, on the sixth (6th) time or on the sixth (6th) day that the second user attempts to view and/or access the received data, the sent data would be inaccessible, thereby preventing the second user from viewing, accessing, or exporting the data.

In addition, the first user may select an option which defines whether the second user can export the received data in an unencrypted state and whether the second user can store the unencrypted data within a memory of the second user's mobile device (i.e., a second mobile device). In further exemplary embodiments, the first user may define whether the second user may be allowed to forward the received data to other users. Thus, if the first user selects the option that allows the second user to forward the received data to a third user, the data would be re-encrypted and sent to the third user according to a similar process in which the data was initially sent to the second user from the first user. Furthermore, if the first user selects the option that allows that the second user to forward the data to third users, the first user may also define whether the third users (1) can export and re-forward the data and (2) whether the third users are limited access to the data based on a number of times that the data is accessed or a specified time period.

In further exemplary embodiments, the method of performing secure messaging according to the present invention further consists of a process of using the second user's phone number, or unique identifier, as a key to encrypt the selected data and the options detailed above. That is, in an exemplary embodiment, the application would use the second user's phone number or unique identifier; or a key generated from the second user's phone number or unique identifier and/or generated from a combination of the sender's and receiver's phone numbers or unique identifiers to encrypt data that is to be sent to the second user. In particular, the application may use (1) the telephone number of the second mobile device as read from the first mobile device; (2) a unique identification information of the second mobile device as read from the first mobile device; (3) a combination of unique identification information from the first and second mobile device; or (4) an identification information of the first mobile device, wherein each of the above may be used to generate a unique encryption key which could be used by the application to encrypt and de-crypt the sent data or message. For example, the unique identification information of the second mobile device could be the phone number of the second mobile device as read from the first mobile device which would be used by the application to generate an encryption key that would be used to prevent forwarding of the encrypted message. That is, the application would determine whether the one-way hash of the second mobile device's phone number which is appended to the data or message matches the one way hash of the second mobile device's phone number as read directly from the second mobile device.

More specifically, in an exemplary embodiment of the present inventive concept, the encryption may be performed by using the phone number of the second user's mobile device. Once the first user selects a desired receiver (i.e., the second user) of the selected data, the application stored on the first mobile device may one-way hash (i.e., one-way encrypt) the selected second user's phone number and append this data to the selected data. Similarly, in alternative exemplary embodiments, the application stored on the first mobile device may also one-hash any one of (1) the telephone number of the second mobile device as read from the first mobile device; (2) a unique identification information of the second mobile device as read from the first mobile device; (3) a combination of unique identification information from the first and second mobile device; or (4) an identification information of the first mobile device. That is, the application according to the present inventive concept may one-way hash unique identifiers and append this data to the selected data before the data is sent to the second user for the purposes of authenticating the first or second user.

In exemplary embodiments, the encrypted data and the one-way hashed data may then be sent to the second user through conventional MMS (picture messaging) communication protocols. Then, upon receiving the encrypted data from the first user as an MMS, the application on the second user's mobile device would attempt to access or view the encrypted data by using a secure messaging application of the present invention, which may be stored within a memory of the second mobile device. In further exemplary embodiments, the secure messaging application on the second mobile device may obtain the phone number of the second user's mobile device by directly accessing the phone number stored on the SIM card or from a memory of the second mobile device, such as ROM. In alternative exemplary embodiments, the unique identification information of the second mobile device may be used by the application to generate an encryption key. For instance, the unique identification information may include the phone number of the mobile device, a serial number of the mobile device, or the like.

The secure messaging application of the present inventive concept obtains the second user's phone number directly from the second mobile device, and may not permit a manual entry of a phone number inputted by the second user in order to ensure security of the secure messaging process. The secure messaging solution application then determines whether the receiver of the encrypted data is an intended recipient by reading the one-way hashed phone number appended to the encrypted data and then comparing the one way hash with a one-way hash of the phone number of the receiver. Thus, if the receiver's (i.e., second user's) one-way hashed phone number, which is obtained directly from the receiver's mobile device, corresponds with the one-way hash of the phone number of the phone number selected by the sender and which was appended to the encrypted data, the application then allows the receiver to decrypt and access the data according to the options defined by the first user.

In exemplary embodiments, the application stored on the first mobile device may also one-hash any one of (1) the telephone number of the second mobile device as read from the first mobile device; (2) a unique identification information of the second mobile device as read from the first mobile device; (3) a combination of unique identification information from the first and second mobile device; or (4) an identification information of the first mobile device. That is, the application according to the present inventive concept may one-way hash unique identifiers and append this data to the selected data before the data is sent to the second user for the purposes of authenticating the first or second user, sender or receiver, as the appropriate origin for the data or as the appropriate recipient of the data.

However, if the one-way hash of the phone number of the receiver does not correspond with the one-way hashed phone number appended to the encrypted data, the receiver is prevented from accessing or viewing the encrypted data. That is, if the one-way hash of the phone number of the receiver, as read directly from the receiver's mobile device, does not correspond with the one-way hashed phone number appended to the encrypted data file, the application determines that the receiver of the encrypted data was not an intended recipient and therefore protects the encrypted data from being accessed or viewed by the receiver.

In addition, in alternative exemplary embodiments, the sender's phone number may be one-way hashed and appended to a selected data which is to be sent to a receiver. Then, the application according to the present invention would compare the one-way hashed phone number of the sender with a one-way hash of the sender as read directly from the receiver's mobile device. However, the present general inventive concept is not limited thereto. That is, the application of the present invention may append the sender's phone number, the receiver's phone number, and/or additional identification number to data which is to be sent to a receiver and then determine whether this information corresponds to a one-way hash of similar information as read directly from the receiver's mobile device.

If, for example, the one-way hashed data appended to the data does not correspond with the one-way hash of similar information as read directly from the second mobile device (i.e., the receiver), the secure messaging application may then display an error message indicating that the receiver is not an authorized recipient. The application may also perform this procedure and display an error message when the initial receiver forwards the encrypted data to other unauthorized recipients. This may also result from the intended “receiver” having forwarded the encrypted MMS data via a third party application which is different than the secure messaging solution application of the present invention or from forwarding the data or data via a conventional standard MMS communication application on the mobile device to an unauthorized recipient. Thus, the one-way hashed information as appended to the encrypted data would not correspond with the one-way hash of similar information as read from the mobile device and therefore the encrypted file could not be decrypted.

Conversely, if the one-way hash of the phone number of the receiver (i.e., second user) does correspond to the one-way hashed phone number as appended to the encrypted data, the application then determines that the receiver is authorized to access and view the encrypted data. That is, if the one-way hash of the phone number of the first receiver, as obtained from the receiver's mobile device, matches the one-way hash of the phone number selected by the first user “sender” and appended to the encrypted data, the application then determines that the first receiver is an intended recipient and therefore allows the first receiver to decrypt, access, export, and view the received data according to the options defined by the first user. Then, upon determining that the “sender” did intend for the current “receiver” to view the data, the secure messaging solution application determines based on the appended flags or selected conditions which define the manner in which the “sender” intended for the “receiver” to view, store, export and/or share the encrypted data. In exemplary embodiments, the application stored on the first mobile device may also one-hash any one of (1) the telephone number of the second mobile device as read from the first mobile device; (2) a unique identification information of the second mobile device as read from the first mobile device; (3) a combination of unique identification information from the first and second mobile device; or (4) an identification information of the first mobile device, wherein each of the above may be used to generate a unique encryption key which could be used by the application to encrypt and de-crypt the sent data or message. That is, the application according to the present inventive concept may one-way hash unique identifiers and append this data to the selected data before the data is sent to the second user for the purposes of authenticating the first or second user, sender or receiver, as the appropriate origin for the data or as the appropriate recipient of the data.

The secure messaging solution application of the present invention further reads the limit flags appended to the sent encrypted data to determine, for instance, how many times the “sender” wanted to allow the “receiver” to view the encrypted data. If the sender defined a limit flag to limit the number of times the “receiver” would be allowed to access and view the data, each time the data is viewed by the “receiver” a counter would be incremented by one. Thus, the application would determine whether the counter is less than the defined limit and allow the “receiver” to access the data if the counter is less than or equal to the number defined by the sender. However, if no limiting options were set for the selected data, the secure messaging solution application proceeds to determine whether an expiration flag has been defined. In particular, if a time limiting option is set, a clock is then checked to determine whether it is currently below the specified time limit or before a date set by the first user. If the clock is below the specified limit and the current date is before the date set by the first user, the application allows the data to be displayed. Otherwise, the data is prevented from being displayed.

In exemplary embodiments, if in a previous step or operation it was determined to move on to determine whether an expiration flag has been set, the secure messaging solution application would read the expiration date flag to determine until when the sender wanted to allow the receiver to view the encrypted data. If no expiration date has been set, then the received data is displayed. However, if an expiration date or time period has been defined, the expiration date and time period is then checked to determine if the current date falls before the expiration date or whether or not the time period has not expired in order to determine whether or not to display the encrypted data. For instance, if the current date is before the expiration date, the received data is displayed. However, if the current date is after the expiration date, then the received data is inaccessible.

Next, the secure messaging solution application then reads an export allowed flag to determine whether the “sender” wanted to allow the “receiver” to be able to export and store an unencrypted copy of the encrypted data on the receiver's mobile device and whether the receiver is allowed unrestricted forwarding of the received data to others or to have unrestricted copying of the encrypted data to other devices or storage media. The secure messaging solution application reads the forward allowed flag to determine if the “sender” wanted to allow the “receiver” to forward encrypted copies of the encrypted data to others possibly with or without restrictions. All recipients would need to have a copy of the secure messaging solution application installed on their mobile device in order to view the encrypted data and to check whether the sender selected any conditions on the manner in which the encrypted data is accessed by other users. This process may be performed each time and on each of the “receivers” devices to determine eligibility to access and view an encrypted data.

In addition, the present inventive concept also includes a method of performing secure messaging for business applications or for users requiring a higher level of security. The business (i.e., enterprise) solution includes a registration process which may be performed by a pre-established designee. The designee is responsible for authenticating an identity of an applicant and also for determining whether registration for the secure messaging solution for an enterprise use has been authorized and/or approved by a governing body, such as an employer, put in place by the “customer” (defined as the enterprise which is purchasing/licensing the solution for use by it's employees).

Upon validating the identity and authorization of the applicant to use the secure messing solution for enterprise use, the designee would then complete an online form to input the following information: (1) Applicant Name, (2) Mobile Device IMEI, (3) Mobile Device Phone Number; and (4) Company Name. The designee would then set flags defining the authorized use of the secure messaging solution for enterprise use. Exemplary embodiments may include the following flags/options that may be set by the customer (1) allow to send communications to anyone within a group or company; (2) allow to send communication to only specified recipients and if selected, an input area is provided to allow the customer to input particular approved recipients; and (3) allow registration of additional recipients without the designee's approval. Upon submitting this information, the secure messaging solution for enterprise use's servers would generate an encryption key or set of encryption keys which is unique to the registered applicant and which is stored only at the secure messaging solution for enterprise use's servers.

Alternatively, in exemplary embodiments, a relationship may be established without a designee involved. In this case, the secure messaging solution for enterprise use includes the ability for users to self-specify a relationship between users so long as both users have been granted this privilege by a designee during an initial registration process (as described above) or at a later operation.

In an exemplary embodiment, the “requestor” initiates a request for a relationship to be established with the “requestee” in the secure messaging solution for enterprise use application on the mobile device. The “requestor” then selects a “requestee” from the mobile device's phone book. The secure messaging solution for enterprise use application then sends the “requestor's” phone number as read directly from the mobile device similar to the process described above and the device's IMEI (device unique identifier) either in plain text or as a one-way hashed to the secure messaging solution for enterprise use's servers.

The secure messaging solution for enterprise use's servers then compares both the “requestor's” phone number and the “IMEI” in either plain text or one-way hash to the phone number and the “IMEI” number registered by the designee on behalf of the “requestor” during the initial registration process described above. In exemplary embodiments, this process may also be performed for specific privileged users (i.e., power users) who are not associated with a particular client, company, or group. Both values must be received together and match the registered values, or otherwise the secure messaging solution for enterprise use application will not be allowed to proceed.

If the “requestor” is validated during the steps described above, then the secure messaging solution for enterprise use application sends the “requestee's” phone number to the secure messaging solution for enterprise use's servers. The “requestor” and “requestee's” registrations are then checked to determine if the designee authorized both the “requestor” and the “requestee” to register additional “recipients” without the designee's involvement. In alternative embodiments, the application determines whether the “recipients” are authorized users according to various predetermined conditions or determines whether the “recipients” are power users who are not associated with a particular company or group. If either the “requestor” or the “requestee” is not authorized according to the registration process to register additional “recipients” without the designee's involvement, then the secure messaging solution for enterprise use application would not be allowed to proceed and therefore the “requestor” would not be able to communicate with the “requestee.”

However, if the “requestor” and “requestee” are authorized to register additional “recipients” without the designee's involvement, then the secure messaging solution for enterprise use's servers check to see whether the companies or groups are listed on the registrations for “requestor” and “requestee” match. In exemplary embodiments, if the application determines that the “requestor” and the “requestee” are power users, the application would skip the process of determining whether the companies or groups of the “requestor” and the “requestee” are listed on the registrations. If the companies or groups do not match then the secure messaging solution for enterprise use application would not be allowed to proceed and therefore the “requestor” would not be allowed to communicate with the “requestee.”

Conversely, if the companies do match or in the case when both the “requestor” and the “requestee” are power users, the secure messaging solution for enterprise use application would then send a request to the “requestee” to establish a relationship that allows the “requestor” and “requestee” to send encrypted messages to each other.

Upon receiving the request, the “requestee” is asked to accept or reject the request in order to establish a relationship allowing the “requestor” and “requestee” to send encrypted messages to each other. If the “requestee” rejects the request, then no further action is taken. If the “requestee” accepts the request, the registrations of both the “requestor” and “requestee” are then updated on the secure messaging solution for enterprise use's servers to reflect that “requestee” is a specified recipient of the “requestor” and that the “requestor” is a specified recipient of the “requestee”.

Upon initiating the secure messaging solution application the “sender” selects a stored data to be sent to the “receiver.” The “sender” may then select the “receiver” from the phone's address book. The secure messaging solution for enterprise use application sends the “sender's” phone number as read from the device (as described above) and the senders device's IMEI (device unique identifier) either in plain text or one-way hashed to the secure messaging solution for enterprise use's servers. The secure messaging solution for enterprise use's servers then compares both the “sender's” phone number and IMEI in either plain text or one-way hashed to the phone number and IMEI number registered by the designee on behalf of the “sender” during the initial registration process described above. Both values must occur together and match the registered values, otherwise the secure messaging solution for enterprise use application would not be allowed to proceed and therefore the “sender” would not be allowed to communicate with the “receiver.”

If the “sender” is validated during the step above, then the secure messaging solution for enterprise use application sends the “receiver's” phone number to the secure messaging solution for enterprise use's servers. The “sender's” and the “receiver's” registrations are checked to determine what “rights” exist for each user. The “Company Names” are then compared. If specified, the company names must match in order to proceed to the next step. The “sender's” registration is checked to determine whether the “sender” is allowed to send to anyone within company. If the answer is “yes”, then the secure messaging solution for enterprise use's servers retrieve the encryption key for the “receiver.”

In an exemplary embodiment, a public key-private key method may be used to authenticate a receiver of data. For instance, in a case where a first user uses a first mobile device to send data to a second user using a second mobile device, the first mobile device includes a public key which corresponds with the second user. That is, the first mobile device obtains or generates a public key specifically for the second user. Then, if the first user selects data which is to be sent to the second user, the application according to the present inventive concept stored on the first mobile device uses the public key for the second user with a desired encryption algorithm to encrypt the selected data. In exemplary embodiments, additional information, options, data, or flags may also be appended the encrypted data. The first mobile device may then send the encrypted data to the second user by conventional communication protocols. For instance, the first mobile device may send the encrypted data to the second user by MMS or SMS communication protocols.

Upon receipt, the application according to the present inventive concept stored on the second mobile device may decrypt the received encrypted data by using the private key corresponding to the second user. In exemplary embodiments, the application may further require a private key corresponding to the second user to decrypt and display the received data. In alternative embodiments, other encryption and decryption methods conventionally known may also be incorporated within the application. That is, the first user and the second user may only require a private key which enables the application to encrypt and decrypt data.

If the answer is “no”, the “sender's” registration is checked to see whether the “sender” is allowed to send data to only specified recipients and whether the “receiver” corresponds to a specified recipient. Also, if the answer to both questions is “yes”, the secure messaging solution for enterprise use's servers retrieve the encryption key for the “receiver.” However, if the answer to either question is “no”, then the secure messaging solution for enterprise use application would not proceed and therefore the “sender” would not be allowed to communicate with the “receiver.”

In addition, if it was determined in the previous step that the “sender” is allowed to send the “receiver” an encrypted message and an encryption key was retrieved for the “receiver”, then the “sender” selects between options which define the manner in which the sent data may be viewed, stored, exported, or shared with others by the “receiver.” The “sender” selects whether the “receiver” would be limited in a number of times that the data can be viewed. If the “receiver” is to be limited, then the number of times the data can be viewed is entered. The “sender” then selects whether the “receiver” can export the data unencrypted and/or store it locally on his/her mobile phone. The “sender” selects whether the “receiver” may forward the data to a “2nd receiver”. Doing this would re-encrypt the data for consumption by the “2nd receiver” using a similar process as described below for encrypting the data by the “sender” for consumption by the “receiver.” The “receiver's” encryption key, as retrieved earlier, may be used as a key to encrypt the selected data and the selected options which define the manner in which data is to be viewed, stored, exported, and forwarded to others. The encrypted data is then sent to the “receiver” through the normal MMS (picture messaging) protocol in use in conventional mobile-to-mobile communication technology. However, the present invention is not limited thereto.

Upon receiving the encrypted data as an MMS, the “receiver” would attempt to view the encrypted data in the secure messaging solution application. The secure messaging solution for enterprise use application would then send the “receiver's” phone number as read from the device (as described above) and the device's IMEI (device unique identifier) either in plain text or one-way hashed to the secure messaging solution for enterprise use's servers. The secure messaging solution for enterprise use's servers would then compare both the “receiver's” phone number and IMEI in either plain text or one-way hashed to the phone number and IMEI number registered by the designee on behalf of the “receiver” (process described above). Both values must occur together and match the registered values or otherwise the secure messaging solution for enterprise use application would not be allowed to proceed. If the “receiver” is validated during the step above, the secure messaging solution for enterprise use's servers retrieve the encryption key for the “receiver”. In exemplary embodiments, the application may use a private key-private key encryption method (i.e., symmetric approach), wherein the application uses a single key to encrypt and decrypt data. Alternatively, the application may also use a public key-private key encryption method (i.e., asymmetric approach), wherein the application uses at least two keys to encrypt and decrypt data. For convenience, an explanation of the private key-public key and private key-private key encryption methods have been omitted since these methods are conventionally known.

The “receiver's” encryption key may be used as a key to decrypt the selected data and the options selected by the “sender”. If the decryption was successful, the secure messaging solution for enterprise use application determines based on the appended flags how the “sender” intended for the “receiver” to view, store, export and/or share the encrypted data. For instance, the secure messaging solution for enterprise use application reads the limit flag to determine how many times the “sender” wanted to allow the “receiver” to view the encrypted data. If no limit is set, the data is displayed. If a limit is set, a counter is then checked to determine whether it is currently below the limit. If the counter is below the limit, the data is displayed and the counter is incremented by a predetermined interval or number. The predetermined interval or number may be equal to one day or one unit of time, such as hour. For example, the predetermined interval or number may equal one (1). However, if the counter is equal to or larger than the limit, then access to the data is denied and no data is displayed.

The secure messaging solution for enterprise use application reads an export allowed flag to determine whether the “sender” wanted to allow the “receiver” to export and/or store an unencrypted copy of the encrypted data on the receiver's mobile device, which would allow for unrestricted forwarding to other users or the copying of the data to other devices/media. The secure messaging solution for enterprise use application of the present invention then reads a forward allowed flag to determine whether the “sender” wanted to allow the “receiver” to forward encrypted copies of the encrypted data to others possibly with or without restrictions. All recipients would need to have a copy of the secure messaging solution for enterprise use application or a compatible application installed on their mobile device in order to view the encrypted data and to check the flags described above. The operations described above will be repeatedly performed each time on each “receivers” device to determine eligibility to access and/or view the encrypted data.

In exemplary embodiments of the secure messaging solution for enterprise use application according to the present invention consists of the following operations. Upon initiating the secure messaging solution application the “sender” selects a stored data to be sent to a “receiver.” The “sender” then selects the “receiver” from the phone's address book. The secure messaging solution for enterprise use application sends the “sender's” phone number as read from the device (as described above) and the device's IMEI (device unique identifier) either in plain text or one-way hashed to the secure messaging solution for enterprise use's servers. The secure messaging solution for enterprise use's servers then compares both the “sender's” phone number and IMEI in either plain text or one-way hashed to the phone number and IMEI number registered by the designee on behalf of the “sender” (process described above). Both values must occur together/match the registered values or the secure messaging solution for enterprise use application will not be allowed to proceed to allow communication between the “receiver” and the “sender.” If the “sender” is validated during the step above, then the secure messaging solution for enterprise use application sends the “receiver's” phone number to the secure messaging solution for enterprise use's servers. The “sender” and “receiver's” registrations are checked to determine what “rights” exist for each user. The Company Names are compared. A match is required to proceed to the next step. The “sender's” registration is checked to see if the “sender” is allowed to send to anyone in company.

If the answer is “yes,” the secure messaging solution for enterprise use's servers retrieve the encryption key for the “receiver.” If the answer is “no”, the “sender's” registration is checked to see whether the “sender” is allowed to send to specified recipients only and if the “receiver” is a specified recipient. If the answer to either question is “yes”, the secure messaging solution for enterprise use's servers retrieve the encryption key for the “receiver.” However, if the answer to both questions is “no,” the secure messaging solution for enterprise use application cannot proceed.

If it was determined in the previous step that the “sender” is allowed to send the “receiver” an encrypted message and an encryption key was retrieved for the “receiver”, then the “sender” selects between options that determine how the data may be viewed, stored or shared with others by the “receiver.” The “sender” selects whether the “receiver” will be limited in the number of time the data can be viewed. If the “receiver” is to be limited then the number of times the data can be viewed is entered. The “sender” selects whether the “receiver” can export the data unencrypted and store it locally on his mobile phone. The “sender” selects whether the “receiver” can forward the data to a “2nd receiver”. Doing this would re-encrypt the data for consumption by the “2nd receiver” using the process as outlined below for encrypting the data by the “sender” for consumption by the “receiver.”

The “sender” selects whether the “receiver” will no longer be able to view the data upon reaching an expiration date. If the “receiver' is to be limited to being unable to view the data after the expiration date then the expiration date is entered. If the “sender” allowed the “receiver' (above) to forward the data to a “2nd receiver”, the “sender” selects whether to limit the “2nd receiver's” rights. For example, the sender can select whether the “2nd receiver” can export a received data, whether the “2nd receiver” can re-forward the data, and whether the “2nd receiver” would be limited to the same number of openings and expiration date as set for the original receiver.

The “receiver's” encryption key, as retrieved earlier, is used as a key to encrypt the selected data and the option selections. The encrypted data is then sent to the “receiver” through the normal MMS (picture messaging) protocol in use in mobile-to-mobile communications today.

Upon receiving the encrypted data as an MMS the “receiver” would attempt to view the encrypted data in the secure messaging solution application. The secure messaging solution for enterprise use application sends the “receiver's” phone number as read from the device (as described above) and the device's IMEI (device unique identifier) either in plain text or one-way hashed to the secure messaging solution for enterprise use's servers.

The secure messaging solution for enterprise use's servers then compares both the “receiver's” phone number and IMEI in either plain text or one-way hashed to the phone number and IMEI number registered by the designee on behalf of the “receiver” (process described above). Both values must occur together/match the registered values or the secure messaging solution for enterprise use application will not be allowed to proceed.

If the “receiver” is validated during the step above, the secure messaging solution for enterprise use's servers retrieve the encryption key for the “receiver.” The “receiver's” encryption key is used as a key to decrypt the selected data and the options selected by the “sender”. If the decryption was successful, the secure messaging solution for enterprise use application determines based on the appended flags how the “sender” intended for the “receiver” to view, store and/or share the encrypted data. The secure messaging solution for enterprise use application reads the limit flag to determine how many times the “sender” wanted to allow the “receiver” to view the encrypted data. If no limit is set the secure messaging solution for enterprise use application proceeds to the expiration date check. If a limit is set, the counter is then checked to determine if it is currently below the limit. If the counter is below the limit, the counter is incremented by 1 and the secure messaging solution for enterprise use application proceeds to the expiration date check. If the counter is equal to the limit no data is displayed.

If in the previous step it was determined to move on to an expiration date check, the secure messaging solution for enterprise use application reads the expiration date flag to determine until when the “sender” wanted to allow the “receiver” to view the encrypted data. If no expiration date has been set, the data is displayed. If an expiration date is set, the expiration date is then checked to determine if the current date falls before the expiration date. If the current date is before the expiration date, the data is displayed. If the current date is after the expiration date, no data is displayed.

The secure messaging solution for enterprise use application reads the export allowed flag to determine if the “sender” wanted to allow the “receiver” to export and store an unencrypted copy of the encrypted data on the mobile device, possibly allowing for unrestricted forwarding to others or copying to other devices/media.

The secure messaging solution for enterprise use application reads the forward allowed flag to determine if the “sender” wanted to allow the “receiver” to forward encrypted copies of the encrypted data to others possibly with or without restrictions. All recipients will need to have a copy of the secure messaging solution for enterprise use application installed on their device to view the encrypted data and the checks performed above will be performed again each time on each “receivers” device to determine eligibility to view the encrypted data.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method for securing data to be transmitted between a plurality of devices, the method comprising:
exchanging encryption keys between first and second devices of the plurality of devices;
selecting digital rights management (DRM) features for the data which is to be transmitted from the first device;
encrypting the data to be transmitted and the selected digital rights management features using at least one distinct key;
transmitting the encrypted data and the selected DRM features to the second device and a third device of the plurality of devices; and
decrypting the encrypted data on the second device using the exchanged encryption keys and displaying the data according to the selected DRM features.

2. The method of claim 1, wherein the data includes text data, picture data, audio data, video data, SMS data, and MMS data.

3. The method of claim 1, wherein the DRM features comprise data expiration time, limit on number of times data is viewable, limits on data export rights, and limits on data forwarding rights.

4. The method of claim 1, wherein the encrypted data is transmitted to a third device of the plurality of devices when an audit requirement exists.

5. The method of claim 3, wherein the audit requirement occurs when the data transmitted between the first and second device is subject to regulatory compliance.

6. The method of claim 4, wherein the third device is a non mobile database.

7. The method of claim 6, wherein the third device is able to access, decrypt, and display the received encrypted data without the limits set by the selected DRM features.

8. The method of claim 1, wherein the encrypted data is stored within an encrypted database on both the first and second devices.

9. The method of claim 1, wherein the exchanged encryption keys between the first and second devices are accessed, maintained, and modified through a key server.

10. The method of claim 7, wherein the key server can revoke the exchanged keys between the first and second device.

11. The method of claim 7, wherein the key server can verify whether the first and second device are authorized to communicate with each other.

12. The method of claim 9, wherein the key server can request status updates from the first and second device to verify whether the devices authorized to communicate with each other.

13. A method to perform secure communication between a first mobile device and a second mobile device, the method comprising:
selecting data using the first mobile device which has a first identification information;
selecting the second mobile device having a second identification information from a first memory of the first mobile device;
appending the second identification information as read from the first memory to the selected data;
sending the selected data with the appended second identification information to the second mobile device,
wherein the data is accessible on the second mobile device when the appended second information corresponds with the second identification information as read from a second memory of the second device.

14. The method of claim 11, wherein the first identification information includes a first telephone number and a first IMEI number of the first mobile device.

15. The method of claim 11, wherein the second identification information includes a second telephone number and a second IMEI number of the second mobile device.

16. The method of claim 13, wherein the data is accessible on the second mobile device when the second telephone number appended to the selected data corresponds to the second telephone number as read directly from the second memory of the second mobile device.

17. The method of claim 14, wherein the second identification information as read from the first memory of the first mobile device is one-way hashed and appended to the selected data.

18. The method of claim 15, wherein the data is accessible on the second mobile device when the one-way hashed second identification information as read from the first memory of the first mobile device corresponds with a one-way hash of the second identification information as read from directly from the second memory of the second mobile device.

19. The method of claim 11, further comprising defining accessibility conditions of the selected data before sending the selected data to the second device.

20. The method of claim 15, further comprising encrypting the selected data and the defined accessibility conditions by using the second identification information as read from the first memory of the first mobile device as a key.

21. The method of claim 15, wherein the defined accessibility conditions are appended to the selected data before sending the selected data to the second device.

22. The method of claim 16, wherein the accessibility conditions include a first option to limit an accessibility to the selected data according to a number of times which the data is accessed by the second mobile device.

23. The method of claim 17, wherein the number of times used in the first option is inputted by a user of the first mobile device.

24. The method of claim 16, wherein the accessibility conditions include a second option to limit an accessibility to the selected data according to an expiration time period of the selected data.

25. The method of claim 19, wherein the expiration time period used in the second option is inputted by a user of the first mobile device.

26. The method of claim 16, wherein the accessibility conditions include a third option to protect the selected data from being forwarded to a third mobile device from the second mobile device.

27. The method of claim 21, wherein a user of the first mobile device selects the third option to protect the selected data from being forwarded to a third mobile device from the second mobile device.

28. A method to perform secure communication between a first mobile device and a second mobile device, the method comprising:
registering the first mobile device having a first identification information with a server as a first authorized user based on the first identification information;
generating an encryption key corresponding to rights granted to the first mobile device;
storing the encryption key within the server; and
determining whether a second identification information of a second mobile device selected by the first mobile device is a second authorized user,
wherein the first mobile device is permitted to communicate with the second mobile device when the server determines that both the first and second mobile devices are authorized users.

29. The method of claim 26, wherein the first identification information includes a first telephone number and a first IMEI number of the first mobile device.

30. The method of claim 26, wherein the second identification information includes a second telephone number and a second IMEI number of the second mobile device.

31. A method for securing data to be transmitted between a plurality of devices, the method comprising:
exchanging distinct encryption keys between first and second devices of the plurality of devices; and
selecting data to be transmitted from the first device to the second device,
wherein a smart security feature automatically encrypts the selected data when the data contains certain data.

32. The method according to claim 31, wherein the certain data includes predetermined language, predetermined images, or other adult rated content.
